(19) United States
(12) Patent Application Publication
(10) Pub. No.: US 2025/0274065 A1
(43) Pub. Date: Aug. 28, 2025

(54) Power generation control method and device for wind power generation unit

(71) Applicant: Zhongshan Power Supply Bureau of Guangdong Power Grid Co Ltd., Zhongshan City (CN)

(72) Inventors: Xiangfeng ZHOU, Zhongshan City (CN); Chunyuan CAI, Zhongshan City (CN); Yongjian LI, Zhongshan City (CN); Lifei LI, Zhongshan City (CN)

(73) Assignee: Zhongshan Power Supply Bureau of Guangdong Power Grid Co Ltd., Zhongshan City (CN)

(21) Appl. No.: 18/808,727

(22) Filed: Aug. 19, 2024

(30) Foreign Application Priority Data
Feb. 27, 2024 (CN) 202410214034.4

(51) Int. Cl. H02P 9/00; F03D 7/02; F03D 9/25; H02P 101/15

(52) U.S. Cl. CPC H02P 9/008; F03D 7/0276; F03D 9/25; F05B 2270/1033; F05B 2270/327; H02P 2101/15

(57) ABSTRACT

A power generation control method and a device for a wind power generation unit are provided. The method includes: acquiring operation data generated during the operation of a wind power generation unit; acquiring data of influence factors of a wind power generator group; determining a component of an electric power generation power regulation component of the wind power generator group; determining the data of the influencing factor and the feature data of the wind power generator unit, the electric power generation power of the wind power generator unit when each piece of operation data of the wind power generator unit is independently adjusted; determining an adjustment and control method for each piece of operation data according to the magnitude of the electric power supply; and controlling an operation method of a wind power generator group according to the adjustment and control method.

### TECHNICAL FIELD

The present invention relates to the technical field of power systems and automation thereof, and in particular, to a power system.

### BACKGROUND

Wind power belongs to an unstable energy source, is greatly affected by the wind speed, and the magnitude of the output force of a wind power field is also variable. Depending on the magnitude of the wind speed, particularly, there is a problem that the wind power field may be processed very little during a period of high peak load, while the wind power field may be processed very much during a period of non-peak load, and therefore, after being connected to a power grid, the wind power field will have a serious effect on the safe operation of the power grid. When the wind speed is less than the cut-in wind speed or greater than the cut-out wind speed, no output power exists in the wind power generation unit; when the wind speed is less than the rated wind speed for the cut-in wind speed, the output power of the wind power generator unit is less than the rated power; when the wind speed is less than the cut-out wind speed for the rated wind speed, the wind power generator unit outputs the rated power. In different seasons of a year, the wind speeds are completely different, and in different time periods of a day, the wind speeds are random, fluctuating and intermittent. Therefore, the wind speed of the small wind power plant is often expressed in expressions such as a minimum wind speed, a maximum wind speed, an average wind speed, a multi-year average wind speed, a calculated average wind speed, a weighted average wind speed, and a mathematical average wind speed. By using the expression forms with different wind speeds, the small wind power field can obtain different machine assembling capacity levels. For different installed capacity levels, the power generation and power generation amount of the small wind farm are also often different in different seasons, optimally leading to different wind energy utilization rates of the small wind power stations, different power generation device utilization rates, and different maximum years of utilization hours of the power generation device.

Under a constant wind speed or a slowly varying wind speed, both an active power control method for a wind power generator unit based on closed-loop rotational speed control and an active power control method for a wind power generator unit based on a pre-set power supply can adjust a fan to a stable equilibrium point. At the operating point, the fan pneumatic power, electromagnetic power, and grid power commands are equal to each other, so that not only the grid power command is responded to, but also the self-electromechanical dynamic stabilization is maintained. Because the fan unit can run at a stable equilibrium point for a long time, the foregoing two methods can achieve an active power control objective, and control performance is similar.

However, in the case of a turbulent wind speed, due to inherent slow dynamic characteristics of a large inertia wind wheel and engineering constraints of a rated capacity of a generator and structural loads of a fan, the fan is difficult to continuously run at a stable equilibrium point, and most of the fans are in dynamic processes of keeping track of the stable equilibrium point and continuously changing speeds. By means of the active power control method for a wind power generator unit based on closed-loop rotational speed control and the active power control method for a wind power generator unit given based on a pre-set power, the control performance is degraded, and the requirements of a power grid for an offshore wind power supply for desired stable output cannot be satisfied.

In view of the problem in the related art that the running reliability of an offshore wind turbine generator set is low and the requirements of a power grid cannot be satisfied, no effective solution has been proposed at present.

### SUMMARY

Embodiments of the present invention provide a technical solution to at least solve the technical problem.

According to one aspect of the embodiments of the present invention, a method for controlling power generation of a wind turbine generator set is provided, comprising: acquiring operation data generated during operation of the wind turbine generator set; acquiring data of an influence factor of the wind power generator group, wherein the data of the influence factor is data corresponding to each factor in an area where the wind power generator group is located, wherein the factors influence the wind power generator group to generate electricity; determining, according to the operation data and the influence factor data, an electric power generation power regulation component of the wind turbine generator set when the operation data of the wind turbine generator set is separately adjusted; determining, according to the electric power generation power regulation component, the influence factor data and feature data of the wind turbine generator set, the electric power generated by the wind turbine generator set when the running data of the wind turbine generator set is separately adjusted; determining a regulation and control manner of each piece of operation data according to the magnitude of the generated power; controlling an operating mode of the wind power generator group according to the regulation and control mode, so that a power generation behavior of the wind power generator group satisfies a power grid demand.

Optionally, acquiring operation data generated during operation of a wind turbine generator set comprises: acquiring, by using an electric Internet of Things system, the operation data generated during operation of the wind turbine generator set.

Optionally, acquiring data of an influence factor of the wind turbine generator group comprises: acquiring the data of the influence factor of the wind turbine generator group by means of a power Internet of things system, wherein the data of the influence factor at least comprises wind power-related data and air density data of an area where the wind turbine generator group is located.

Optionally, when determining, according to the operation data and the influence factor data, to separately adjust a gearbox step-up ratio in the operation data of the wind power generator group, the power generation power regulation and control component of the wind power generator unit comprises: when determining, according to a first formula and according to the operation data and the influence factor data, to separately adjust a gearbox step-up ratio in the operation data of the wind power generator unit, the electric power generation power regulation component of the wind turbine generator set, wherein the first formula is: ΔP_{SWi}^{ω}(t)=k_{Wi}n_{SWI}(t−1)T_{SWGi}(t−1)Δω_{SWI}(t), ΔP_{SWI}(t) representing the power generation power regulation component of the ith wind turbine generator group in the t time period, n_{SWi}(t−1) denotes a gearbox step-up ratio of the ith wind turbine generator set in the t−1 period, and T_{SWGi}(t−1) denotes a generator electromagnetic torque of the ith wind turbine generator set in the t−1 period, Δω_{SWEi}(t) represents a regulation component of a rotation speed of a wind rotor of the ith wind motor group in a t time period, k_{wi}=k_{Si}*k_{Ii}*k_{Ai}*k_{Qj}*k_{Ci}, k_{Si} represents an influence coefficient of a wind speed in an area where the ith wind motor group is located, k_{Ii} represents the influence coefficient of the wind turbulence in the area where the ith wind turbine generator group is located, and k_{Ai} represents the influence coefficient of the wind direction in the area where the ith wind turbine generator group is located, k_{Qi} denotes an influence coefficient of an amount of wind coming from an area where the ith wind turbine generator group is located, and k_{Ci} denotes an efficiency of converting wind energy at sea in the area where the ith wind turbine generator group is located.

Optionally, when determining, according to the operation data and the influence factor data, to separately adjust the generator electromagnetic torque in the operation data of the wind power generator group, the power generation power regulation component of the wind power generator group comprises: when determining, according to a second formula and according to the operation data and the influence factor data, to separately adjust a generator electromagnetic torque in the operation data of the wind power generator group, an electric power generation power regulation component of the wind power generator unit, wherein the second formula is: ΔP_{SWi}^{ω}(t)=k_{Wi}n_{SWi}(t−1)T_{SWGi}(t−1)Δω_{SWi}(t), ΔP_{SWi} (t) representing an electric power generation power regulation component of the wind power generator unit in the ith time period t when the electromagnetic torque of the generator is separately adjusted, ω_{SWGi}(t−1) denotes a gearbox step-up ratio of the ith wind turbine generator set in the t−1 period, and ΔT_{SWGi}(t) denotes a regulation component of an engine electromagnetic torque of the ith wind turbine generator set in the t−1 period.

Optionally, when determining, according to the operation data and the influence factor data, to separately adjust the rotation speed of the wind rotor in the operation data of the wind turbine generator group, the power generation power regulation and control component of the wind power generator unit comprises: when determining, according to the operation data and the influence factor data, to separately adjust the rotation speed of a wind wheel in the operation data of the wind power generator unit by means of a third formula, an electric power generation power regulation component of the wind turbine generator set, wherein the third formula is: ΔP_{SWi}^{ω}(t)=k_{Wi}ω_{SWEi}(t−1)T_{SWGi}(t−1)Δn_{SWi}(t), which ΔP_{SWi(t)} represents an electric power generation power regulation component of the ith wind turbine generator set during a time period t when the rotational speed of the wind turbine wheel is separately adjusted, a regulation component Δn_{SWi}(t) representing a gearbox step-up ratio of the ith said wind power generator group in the t time period.

Optionally, when it is determined to separately adjust a gearbox step-up ratio in the operation data of the wind turbine generator set according to the electric power generation power regulation component, the data of the influencing factor and the characteristic data of the wind turbine generator set, the electric power generation of the wind power generator unit comprises: determining, by means of a fourth formula and according to the electric power generation power regulation component, the influence factor data and feature data of the wind power generator unit, a gear box increase rate ratio in the operation data of the wind power generator unit to be separately adjusted, the electric power generation power of the wind turbine generator group, wherein the fourth formula is:

$${P}_{SWi ( t )} = {k}_{Si} * {k}_{Ii} * {k}_{Ai} * {k}_{Qi} * {k}_{Ci} * \frac{{D}_{i} * {A}_{i} * {v}_{i}^{3}}{2} + {k}_{SWi 1} * {P}_{SWi ( t )}^{ω} ,$$

P_{SWi(t)} representing the electric power generation capacity of the ith wind turbine generator set in the t time period, Dᵢ representing the air density in the area where the ith wind turbine generator set is located, Aᵢ representing the swept area of the ith wind turbine generator set, vᵢ representing the wind speed of the ith wind turbine generator set, and k_{SWi1} representing the regulation coefficient of the gearbox step-up ratio of the ith wind turbine generator set.

Optionally, when determining separately adjusting the generator electromagnetic torque in the operation data of the wind turbine generator set according to the generated power regulation component, the data of the influence factor and the feature data of the wind turbine generator set, the electric power generation of the wind power generator unit comprises: determining, by means of a fifth formula and according to the electric power generation power regulation component, the influence factor data and feature data of the wind power generator unit, to separately adjust an electromagnetic torque of a generator in the operation data of the wind power generator unit, the generated power of the wind turbine generator set, wherein the fifth formula is:

$${P}_{SWi ( t )} = {k}_{Si} * {k}_{Ii} * {k}_{Ai} * {k}_{Qi} * {k}_{Ci} * \frac{{D}_{i} * {A}_{i} * {v}_{i}^{3}}{2} + {k}_{SWi 2} * {P}_{SWi ( t )}^{T} ,$$

k_{SWi2} representing a regulation coefficient of a generator electromagnetic torque of the ith wind turbine generator set.

Optionally, when determining, according to the electric power generation power regulation component, the influence factor data and the characteristic data of the wind turbine generator set, to separately adjust the rotation speed of the wind turbine in the operation data of the wind turbine generator set, the electric power generation power of the wind turbine generator set comprises: determining, by means of a sixth formula and according to the electric power generation power regulation component, the influence factor data and the feature data of the wind turbine generator set, when the rotational speed of the wind turbine in the running wind data of the wind turbine generator set is separately adjusted, the generated power of the wind turbine generator group, wherein the sixth formula is:

$${P}_{SWi ( t )} = {k}_{Si} * {k}_{Ii} * {k}_{Ai} * {k}_{Qi} * {k}_{Ci} * \frac{{D}_{i} * {A}_{i} * {v}_{i}^{3}}{2} + {k}_{SWi 3} * {P}_{SWi ( t )}^{T} ,$$

k_{SWi3} representing a regulation coefficient of a rotation speed of a wind rotor of the ith wind turbine generator group.

According to another aspect of the embodiments of the present invention, a power generation control device for a wind turbine generator set is further provided. The device comprises: a first acquiring unit, configured to acquire operation data generated during running of the wind turbine generator set; a second acquisition unit for acquiring data of an influence factor of the wind power generator group, wherein the data of the influence factor is data corresponding to each factor in an area where the wind power generator group is located which influences the power generation of the wind power generator group; a first determining unit, configured to determine, according to the operation data and the influence factor data, an electric power generation power regulation component of the wind turbine generator set when the operation data of the wind turbine generator set is separately adjusted; a second determining unit, configured to determine, according to the power generation power regulation component, the influence factor data, and feature data of the wind turbine generator group, power generation of the wind turbine generator group when the running data of the wind turbine generator group is separately adjusted; a third determining unit, configured to determine a regulation manner of each piece of operation data according to the power generation capacity; and a control unit for controlling an operating mode of the wind power generator group according to the regulation and control mode, so that a power generation behavior of the wind power generator group satisfies a power grid demand.

Optionally, the first acquiring unit comprises: a first acquiring module, configured to acquire, by using an electric Internet of Things system, the operation data generated during an operation process of the wind turbine generator set.

Optionally, the second acquisition unit comprises: a second acquisition module for acquiring the data of the influence factors of the wind power generator group via the power Internet of things system, wherein the data of the influence factors at least comprise wind power-related data and air density data of an area where the wind power generator group is located.

Optionally, the first determination unit comprises: a first determination module, configured to, according to the operation data and the factor data, determine, by using a first formula, to separately adjust a gearbox step-up ratio in the operation data of the wind turbine generator group, the electric power generation power regulation component of the wind turbine generator set, wherein the first formula is: ΔP_{SWi}(t)=k_{Wi}n_{SWi}(t−1)T_{SWGi}(t−1)Δω_{SWi}(t), ΔP_{SWi}(t) representing the electric power generation power regulation component of the ith wind turbine generator set in t time period, n_{SWi}(t−1) denotes a gearbox step-up ratio of the ith wind turbine generator set in the t−1 period, and T_{SWGi}(t−1) denotes a generator electromagnetic torque of the ith wind turbine generator set in the t−1 period, Δω_{SWFi}(t) represents a regulation component of a rotation speed of a wind rotor of the ith wind motor group in a t time period, k_{wi}=k_{Si}*k_{Ii}*k_{Ai}*k_{Qi}*k_{Ci}, k_{Si} represents an influence coefficient of a wind speed in an area where the ith wind motor group is located, k_{Ii} represents the influence coefficient of the wind turbulence in the area where the ith wind turbine generator group is located, and k_{Ai} represents the influence coefficient of the wind direction in the area where the ith wind turbine generator group is located, k_{Qi} denotes an influence coefficient of an amount of wind coming from an area where the ith wind turbine generator group is located, and k_{Ci} denotes an efficiency of converting wind energy at sea in the area where the ith wind turbine generator group is located.

Optionally, the first determining unit comprises: a second determining unit, configured to, according to the operation data and the factor data, determine, by using a second formula, to separately adjust the generator electromagnetic torque in the operation data of the wind turbine generator group, an electric power generation power regulation component of the wind power generator unit, wherein the second formula is: ΔP_{SWi}^{T}(t)=k_{Wi}ω_{SWFi}(t−1)n_{SWi}(t−1)ΔT_{SWCi}(t), ΔP_{SWi(t)} representing an electric power generation power regulation component of the wind power generator unit in the ith time period t when the electromagnetic torque of the generator is separately adjusted, ω_{SWFi}(t−1) denotes a gearbox step-up ratio of the ith wind turbine generator set in the t−1 period, and ΔT_{SWGi}(t) denotes a regulation component of an engine electromagnetic torque of the ith wind turbine generator set in the t−1 period.

Optionally, the first determining unit comprises: a third determining unit, configured to, by using a third formula, determine, according to the operation data and the factor data, to separately adjust a rotation speed of a rotor in the operation data of the wind turbine generator group, an electric power generation power regulation component of the wind turbine generator set, wherein the third formula is: Δ_{SWi}ⁿ(t)=k_{Wi}ω_{SWEi}(t−1)T_{SWGi}(t−1)Δn_{SWi}(t), ΔP_{SWi(t)} which represents an electric power generation power regulation component of the ith wind turbine generator set during a time period t when the rotational speed of the wind turbine wheel is separately adjusted, a regulation component Δn_{SWi}(t) representing a gearbox step-up ratio of the ith said wind power generator group in the t time period.

Optionally, the second determining unit comprises: a fourth determining unit, configured to, by using a fourth formula, determine, according to the power generation power regulation and control amount component, the factor data, and feature data of the wind turbine generator set, to separately adjust a gearbox step-up ratio in the operation data of the wind turbine generator set, the electric power generation power of the wind turbine generator group, wherein the fourth formula is:

$${P}_{SWi ( t )} = {k}_{Si} * {k}_{Ii} * {k}_{Ai} * {k}_{Qi} * {k}_{Ci} * \frac{{D}_{i} * {A}_{i} * {v}_{i}^{3}}{2} + {k}_{SWi 1} * {P}_{SWi ( t )}^{ω} ,$$

P_{SWi(t)} indicates an air density of a region where the ith air motor group is located, and Dᵢ denotes an air density of a region where the ith air motor group is located, Aᵢ indicates a swept area of the ith air motor group, vᵢ denotes a wind speed of the ith wind turbine generator set, and k_{SWi1} denotes a regulation coefficient of a gearbox step-up ratio of the ith wind turbine generator set.

Optionally, the second determining unit comprises: a fifth determining unit, configured to separately adjust the generator electromagnetic torque in the operation data of the wind power generator group according to a fifth formula and the power generation power regulation component, the factor data, and the feature data of the wind power generator group, the generated power of the wind turbine generator set, wherein the fifth formula is:

$${P}_{SWi ( t )} = {k}_{Si} * {k}_{Ii} * {k}_{Ai} * {k}_{Qi} * {k}_{Ci} * \frac{{D}_{i} * {A}_{i} * {v}_{i}^{3}}{2} + {k}_{SWi 2} * {P}_{SWi ( t )}^{T} ,$$

k_{SWi2} representing a regulation coefficient of a generator electromagnetic torque of the ith wind turbine generator set.

Optionally, the second determining unit comprises: a sixth determining unit, configured to determine, by using a sixth formula and according to the electric power generation power regulation component, the factor data, and the feature data of the wind turbine generator set, when the rotational speed of the wind turbine in the running data of the wind turbine generator set is separately adjusted, the generated power of the wind turbine generator group, wherein the sixth formula is:

$${P}_{SWi ( t )} = {k}_{Si} * {k}_{Ii} * {k}_{Ai} * {k}_{Qi} * {k}_{Ci} * \frac{{D}_{i} * {A}_{i} * {v}_{i}^{3}}{2} + {k}_{SWi 3} * {P}_{SWi ( t )}^{T} ,$$

k_{SWi3} representing a regulation coefficient of a rotation speed of a wind rotor of the ith wind turbine generator group.

According to another aspect of the embodiments of the present invention, a computer readable storage medium is also provided. The computer readable storage medium comprises a stored program, wherein the program executes the method for controlling power generation of a wind turbine generator set according to any one of the described items.

According to another aspect of the embodiments of the present invention, a processor is further provided, and the processor is used for running a program, wherein when the program runs, the method for controlling power generation of a wind turbine generator set according to any one of the described items is executed.

In the embodiments of the present invention, operation data generated during running of a wind turbine generator set is acquired; acquiring data of an influence factor of a wind turbine generator group, wherein the data of the influence factor is data corresponding to various factors in an area where the wind turbine generator group is located, the factors affecting power generation of the wind turbine generator group; determining, according to the operation data and the influence factor data, a component of an electric power generation power regulation component of the wind power generator group when each operation data of the wind power generator group is independently adjusted; determining, according to the components of the electric power regulation and control amount, the data of the influencing factor and the feature data of the wind power generator unit, the electric power generation power of the wind power generator unit when each piece of operation data of the wind power generator unit is independently adjusted; determining a regulation and control mode of each piece of operation data according to the magnitude of the power supply; controlling an operating mode of a wind power generator group according to a regulation and control mode, so that a power generation behavior of the wind power generator group satisfies a power grid demand. By means of the technical solution provided in the present invention, the purpose of separately adjusting a speed increase ratio of a gearbox, an electromagnetic torque of a generator, and a rotation speed of a wind wheel, so as to safely regulate and control the power of a wind power generator group is achieved, the technical effect of improving the power generation stability of the wind power generator group is achieved, and at the same time, the output of the wind power generator group satisfies a power grid scheduling requirement, thereby solving the technical problem.

### BRIEF DESCRIPTION OF THE DRAWINGS

Drawings, provided for further understanding of the present invention and forming a part of the specification, are used to explain the present invention together with embodiments of the present invention rather than to limit the present invention. In the drawings:

FIG. 1 is a hardware structure block diagram of a mobile terminal of a method for controlling power generation of a wind turbine generator set according to an embodiment of the present invention;

FIG. 2 is a flowchart of a method for controlling power generation of a wind turbine generator set according to an embodiment of the present disclosure;

FIG. 3 is a schematic diagram of a power generation control device for a wind turbine generator set according to an embodiment of the present disclosure.

### DETAILED DESCRIPTION OF EMBODIMENTS

To make persons skilled in the art better understand the solutions of the present invention, the following clearly and completely describes the technical solutions in the embodiments of the present invention with reference to the accompanying drawings in the embodiments of the present invention. Apparently, the described embodiments are merely a part rather than all of the embodiments of the present invention. All other embodiments obtained by persons of ordinary skill in the art based on the embodiments of the present invention without creative efforts shall belong to the scope of protection of the present invention.

It should be noted that, terms such as ‘first’ and ‘second’ in the specification, claims, and the accompanying drawings of the present invention are used to distinguish similar objects, but are not necessarily used to describe a specific sequence or order. It should be understood that the data so used may be interchanged where appropriate so that the embodiments of the invention described herein can be implemented in sequences other than those illustrated or described herein. In addition, the terms ‘include’ and ‘have’, and any variations thereof, are intended to cover a non-exclusive inclusion, for example, a process, method, system, product, or apparatus that includes a series of steps or units is not necessarily limited to those steps or units that are expressly listed, but may include other steps or units that are not expressly listed or inherent to such process, method, product, or apparatus.

As introduced in the background art, due to inherent slow dynamic characteristics of a large inertia wind turbine and engineering constraints on rated capacity of a generator and structural load of a fan, the fan is difficult to continuously run at a stable balance point, and is mostly in a dynamic process of tracking the stable balance point and continuously changing speed. By means of the active power control method for a wind power generator unit based on closed-loop rotational speed control and the active power control method for a wind power generator unit given based on a pre-set power, the control performance is degraded, and the requirements of a power grid for an offshore wind power supply for desired stable output cannot be satisfied. In view of the foregoing defects, embodiments of the present invention provide a method and an apparatus for controlling power generation of a wind turbine generator set, a computer readable storage medium, and a processor.

The following clearly and completely describes the technical solutions in the embodiments of the present invention with reference to the accompanying drawings in the embodiments of the present invention.

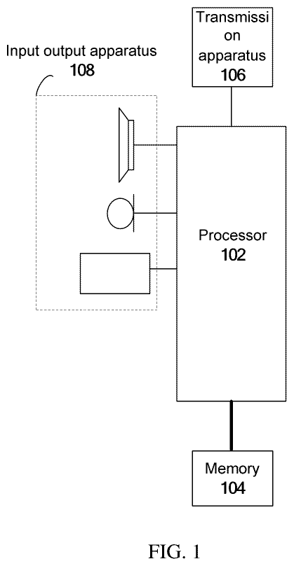

The method embodiments provided in the embodiments of the present invention may be executed in a mobile terminal, a computer terminal, or a similar computing apparatus. Taking running on a mobile terminal as an example, FIG. 1 is a hardware structure block diagram of a mobile terminal in a method for controlling power generation of a wind turbine generator set according to an embodiment of the present invention. As shown in FIG. 1, the mobile terminal may include one or more (only one is shown in FIG. 1) processors 102 (the processors 102 may include, but are not limited to, a processing apparatus such as a microprocessor MCU or a programmable logic device FPGA) and a memory 104 for storing data, wherein the mobile terminal can further include a transmission device 106 and an input/output device 108 for a communication function. A person of ordinary skill in the art may understand that the structure shown in FIG. 1 is merely exemplary, which does not limit the structure of the foregoing mobile terminal. For example, the mobile terminal may further include more or less components than shown in FIG. 1, or have a different configuration from that shown in FIG. 1.

The memory 104 may be used for storing a computer program, for example, a software program and modules of application software, such as a computer program corresponding to the power generation control method for a wind power generator unit in the embodiments of the present invention. The processor 102 runs the computer program stored in the memory 104, so as to execute various functional applications and data processing, that is, to implement the foregoing method. Memory 104 may include high-speed random access memory, and may also include non-volatile memory, such as one or more magnetic storage devices, flash memory, or other non-volatile solid-state memory. In some instances, memory 104 may further include memory remotely located with respect to processor 102, which may be connected to mobile terminals over a network. Examples of such networks include, but are not limited to, the Internet, intranets, local area networks, mobile communication networks, and combinations thereof. The transmitting device 106 is used to receive or transmit data via a network. Specific examples of the described network may include a wireless network provided by a communication provider of the mobile terminal. In one example, the transfer device 106 may comprise a Network Interface Controller (NIC) that may be coupled to other network devices via a base station to communicate with the Internet. In one example, the transmission device 106 may be a radio frequency (RF) module for communicating wirelessly with the Internet.

According to an embodiment of the present invention, a method for controlling power generation of a wind turbine generator set is provided. It should be noted that the steps shown in the flowchart of the figure may be executed in a computer system such as a set of computer executable instructions. In addition, although a logic sequence is shown in the flowchart, in some cases, the shown or described steps may be executed in a sequence different from that described here.

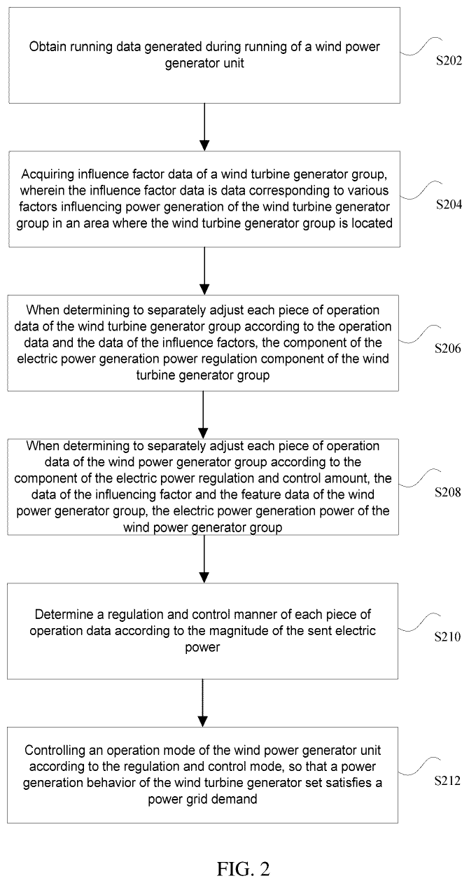

FIG. 2 is a flowchart of a power generation control method for a wind power generator unit according to an embodiment of the present invention. As shown in FIG. 2, the power generation control method for a wind power generator unit comprises the following steps:
Step S202: Obtain running data generated during running of a wind turbine generator set.

Optionally, the running data may include, but is not limited to, a generated power, a speed increase ratio of a gearbox of a unit, an electromagnetic torque of a generator, a rotation speed of a fan wheel, and the like.

It should be noted that the wind turbine generator set in the embodiment of the present invention may be an offshore wind turbine generator set.
Step S204: acquiring data of influence factors of a wind turbine generator group, wherein the data of the influence factors are data corresponding to various factors in an area where the wind turbine generator group is located, wherein the factors influence the wind turbine generator group to generate power.

Optionally, the foregoing impact factor data may include, but is not limited to, real-time data such as a wind speed at sea, an air density, intermittent wind intake, wind direction, wind volume, and sea wave.
Step S206: determining, according to the operation data and the influence factor data, a component of an electric power generation power regulation component of the wind turbine generator group when each operation data of the wind turbine generator group is separately adjusted.

In this embodiment, the component of the electric power generation power regulation and control quantity of the wind turbine generator set when a certain operating parameter of the wind turbine generator set is separately adjusted may be determined according to the acquired operating data and the acquired data of the influence factors. No further description will be given below.
Step S208, determining, according to the electric power adjustment component, the influence factor data and the feature data of the wind turbine generator set, the electric power generation power of the wind turbine generator set when each piece of operation data of the wind turbine generator set is separately adjusted.

In this embodiment, the generated power of the wind turbine generator group when a certain piece of operation data of the wind turbine generator group is adjusted may be determined according to the described generated power regulation amount component, the described influence factor data and the feature data of the wind turbine generator group.
Step S210: determining an adjustment and control manner for each piece of operation data according to the magnitude of the sent electric power.

In this embodiment, the power generation power of a wind power generator unit when a certain operation parameter is adjusted can be separately compared in terms of magnitude, so as to determine an adjustment method for each piece of operation data, thereby enabling the regulation and control of the wind power generator unit to determine the stability and power generation efficiency of the power generation thereof.
Step S212, controlling an operation mode of the wind power generator group according to the regulation and control mode, so that a power generation behavior of the wind power generator group satisfies a power grid demand.

It can be seen from the foregoing description that, in the embodiments of the present invention, operation data generated during running of a wind turbine generator set is acquired; acquiring data of an influence factor of a wind turbine generator group, wherein the data of the influence factor is data corresponding to various factors in an area where the wind turbine generator group is located, the factors affecting power generation of the wind turbine generator group; determining, according to the operation data and the influence factor data, a component of an electric power generation power regulation component of the wind power generator group when each operation data of the wind power generator group is independently adjusted; determining, according to the components of the electric power regulation and control amount, the data of the influencing factor and the feature data of the wind power generator unit, the electric power generation power of the wind power generator unit when each piece of operation data of the wind power generator unit is independently adjusted; determining a regulation and control mode of each piece of operation data according to the magnitude of the power supply; the operation mode of the wind power generator group is controlled according to the regulation and control mode, so that the power generation behavior of the wind power generator group satisfies the requirements of the power grid. The purpose of independently adjusting the speed increase ratio of the gearbox, the electromagnetic torque of the generator and the rotation speed of the wind wheel, so as to safely regulate and control the power of the wind power generator group is achieved, the technical effect of improving the power generation stability of the wind power generator group is achieved, and at the same time, the output of the wind power generator group satisfies the requirements of grid scheduling.

Therefore, by means of the method for controlling power generation of a wind turbine generator set provided in the embodiments of the present invention, the technical problem is solved.

According to the embodiments of the present invention, acquiring operation data generated during an operation process of a wind turbine generator set comprises: acquiring the operation data generated during the operation process of the wind turbine generator set through an electric Internet of Things system.

In this embodiment, an electricity Internet of Things system may be used to acquire operation data of a wind power station and a wind turbine generator set thereof, for example, a generated power, a speed increase ratio of a gearbox of the generator set, an electromagnetic torque of a generator, a rotation speed of a wind turbine, and the like.

According to the embodiments of the present invention, acquiring data of an influence factor of a wind turbine generator group may comprise: acquiring data of an influence factor of the wind turbine generator group by means of a power Internet of Things system, wherein the data of the influence factor at least comprises wind power-related data and air density data of an area where the wind turbine generator group is located.

In this embodiment, the power Internet of Things system can be used to acquire real-time data, i.e., influence factor data, such as marine wind speed, air density, wind turbulence, wind direction, wind volume, and sea wave.

According to the above embodiments of the present disclosure, when determining, according to the operation data and the factor data, to separately adjust the gearbox step-up ratio in the operation data of the wind turbine generator, a power generation power regulation component of a wind power generator unit, comprising: when determining, by means of a first formula and according to operation data and influence factor data, a gearbox step-up ratio in independently adjusting the operation data of the wind power generator unit, a power generation power regulation component of a wind power generator unit, wherein a first formula is: ΔP_{SWi}^{ω}(t)=k_{Wi}n_{SWi}(t−1)T_{SWGi} (t−1)Δω_{SWi}(t), ΔP_{SWi}(t) represents a power generation power regulation component of an ith wind power generator unit in a t time period, n_{SWi}(t−1) represents the gearbox step-up ratio of the ith wind power generator group in the t−1 period, T_{SWGi}(t−1) represents the generator electromagnetic torque of the ith wind power generator group in the t−1 period, Δω_{SWFi}(t) represents the regulation component of the rotation speed of the wind rotor of the ith wind motor group in the t time period, and k_{wi}=k_{Si}*k_{Ii}*k_{Ai}*k_{Qi}*k_{Ci}, k_{Si} represents the influence coefficient of the wind speed in the region where the ith wind motor group is located, k_{Ii} represents the influence coefficient of the incoming air turbulence in the area where the ith wind turbine generator group is located, and k_{Ai} represents the influence coefficient of the wind direction in the area where the ith wind turbine generator group is located, k_{Qi} denotes the influence coefficient of the amount of wind coming into the zone where the ith wind turbine generator group is located, and k_{Ci} denotes the conversion efficiency of wind energy at sea in the zone where the ith wind turbine generator group is located.

In this embodiment, when the speed-up ratio of the gearbox is adjusted separately, the power generation power regulation component of the ith wind turbine generator group in the t period may be determined through the first formula, and the power generation power regulation component of the ith wind turbine generator group in the t period may be calculated accurately and reasonably through the parameters.

According to the embodiment of the present disclosure, when determining, according to the operation data and the factor data, to separately adjust the generator electromagnetic torque in the operation data of the wind turbine generator group, a power generation power regulation component of a wind power generator unit, comprising: when determining, by means of a second formula and according to operation data and influencing factor data, an electromagnetic torque of a generator in independently adjusting the operation data of the wind power generator unit, a power generation power regulation component of a wind power generator unit, wherein a second formula is: ΔP_{SWi}^{T}(t)=k_{Wi}ω_{SWFi}(t−1)n_{SWi}(t−1)ΔT_{SWGi}(t), ΔP_{SWi(t)} represents a power generation power regulation component of an ith wind power generator unit during a time period t when an electromagnetic torque of a generator is separately adjusted, ω_{SWEi}(t−1) denotes a gearbox step-up ratio of the ith wind power generator group in the t−1 period, and ΔT_{SWGi}(t) denotes a regulation component of an engine electromagnetic torque of the ith wind power generator group in the t−1 period.

In this embodiment, when an electromagnetic torque of a generator is separately adjusted, a component of an electric power regulation and control quantity of an ith electric generator set in a t time period can be calculated by means of the described second calculation, and a component of an electric power regulation and control quantity of an ith electric generator set in a t time period can be accurately and reasonably calculated by means of the described parameters.

According to the above embodiments of the present disclosure, when determining, according to the operation data and the factor data, to separately adjust the rotation speed of the rotor in the operation data of the wind turbine generator group, a power generation power regulation component of a wind power generator unit, comprising: determining, by means of a third formula and according to operation data and influencing factor data, a rotation speed of a wind wheel in independently adjusting the operation data of the wind power generator unit, a power generation power regulation component of a wind power generator unit, wherein a third formula is: ΔP_{SWi}ⁿ(t)=k_{Wi}ω_{SWEi}(t−1)T_{SWGi}(t−1)Δn_{SWi}(t), ΔP_{SWi(t)} representing a power generation power regulation component of an ith wind power generator unit during a time period t when the rotational speed of a wind wheel is separately adjusted, Δn_{SWi}(t) representing a gearbox step-up ratio of the ith wind power generator group in the t time period.

In this embodiment, when the rotation speed of the impeller is separately adjusted, the electric power generation power regulation component of the ith electric generator set in the t time period can be calculated through the described third formula, and the electric power generation power regulation component of the ith electric generator set in the t time period can be calculated accurately and reasonably through the described parameters.

According to the described embodiments of the present invention, when determining, according to the electric power adjustment component, the influence factor data and the characteristic data of the wind power generator unit, to separately adjust the gearbox step-up ratio in the operation data of the wind power generator unit, the power generation of a wind power generator unit comprises: determining, by means of a fourth formula and according to a component of an electric power regulation amount, data of an influencing factor and feature data of the wind power generator unit, when a gear box speed increase ratio in operation data of the wind power generator unit is separately adjusted, the electric power generation power of the wind turbine generator group, wherein a fourth formula is:

$${P}_{SWi ( t )} = {k}_{Si} * {k}_{Ii} * {k}_{Ai} * {k}_{Qi} * {k}_{Ci} * \frac{{D}_{i} * {A}_{i} * {v}_{i}^{3}}{2} + {k}_{SWi 1} * {P}_{SWi ( t )}^{ω} ,$$

P_{SWi(t)} denotes an air density of a region where the ith wind turbine generator group is located, and Dᵢ denotes a swept area of the ith wind turbine generator group, Aᵢ denotes a wind speed of an ith wind turbine generator set, and vᵢ denotes a regulation coefficient of a gearbox step-up ratio of the ith wind turbine generator set, k_{SWi1} denotes a regulation coefficient representing a gearbox step-up ratio of the ith wind turbine generator group, and denotes a regulation coefficient representing a gearbox step-up ratio of the ith wind turbine generator group.

In this embodiment, when a speed-up ratio of a gearbox is separately adjusted, information about the Internet of things can be used to share data security management on output power of a wind power generator unit at sea, and then the output power of the wind power generator unit of the ith time period t is adjusted and controlled as a calculation result of a fourth formula.

In addition, the above formula can be transformed into the following formula:

$${P}_{SWi ( t )} = {k}_{Wi} * {k}_{Ci} * \frac{{D}_{i} * {A}_{i} * {v}_{i}^{3}}{2} + {k}_{SWi 1} * {P}_{SWi ( t )}^{ω} ,$$

P_{SWi}(t) power is generated for the ith group of offshore wind power generators in the time period t; vᵢ is a wind speed of an ith offshore wind power unit; Aᵢ is a wind sweeping area of an ith offshore wind power unit, and

$${A}_{i} = \frac{π {R}_{i}^{2}}{2} ,$$

Rᵢ is wind vane length of the ith offshore wind power unit; Dᵢ is the air density of the ith offshore wind power unit. k_{SWi1} is a regulation coefficient of a gearbox step-up ratio of the ith wind power generator group in the time period t−1.

The above-mentioned gearbox step-up ratio adjustment coefficient of the wind turbine generator set is set as:

$$\{ \begin{matrix}{k}_{SWi 1} ( t ) ∈ ( 0.8 , 1. ] , & Δ {P}_{SWi 1} ( t ) = {k}_{SWi 1} Δ {\tilde{P}}_{SWi} ( t ) & 0 \leq Δ v ( t ) \leq {k}_{v 1} v ( t - 1 ) \\ {k}_{SWi 1} ( t ) ∈ ( 0.5 , 0.8 ] , & Δ {P}_{SWi 1} ( t ) = {k}_{SWi 1} ( t ) Δ {\tilde{P}}_{SWi} ( t ) & {k}_{v 1} v ( t - 1 ) < Δ v ( t ) \leq {k}_{v 2} v ( t - 1 ) \\ {k}_{SWi 1} ( t ) ∈ ( 0.3 , 0.5 ] , & Δ {P}_{SWi 1} ( t ) = {k}_{SWi 1} ( t ) Δ {\tilde{P}}_{SWi} ( t ) & {k}_{v 2} v ( t - 1 ) < Δ v ( t ) \leq {k}_{v 3} v ( t - 1 ) \\ {k}_{SWi 1} ( t ) ∈ [ 0.3 ] , & Δ {P}_{SWi 1} ( t ) = {k}_{SWi 1} ( t ) Δ {\tilde{P}}_{SWi} ( t ) & {k}_{v 3} v ( t - 1 ) < Δ v ( t ) \leq {k}_{v 4} v ( t - 1 )\end{matrix} ,$$

kᵥ₁, kᵥ₂, kᵥ₃, kᵥ₄ in which the coefficients are respectively wind speed boundary coefficients 0≤kᵥ₁<<kᵥ₂<kᵥ₃<kᵥ₄<nᵥ, nᵥ=2-100 of areas where the wind turbine generator set is located.

In the embodiments of the present invention, regulation coefficients of a gearbox step-up ratio, an electromagnetic torque of a generator, and a rotation speed of a wind turbine of a wind turbine may be determined by using an expert method according to operation data.

According to the embodiment of the present disclosure, when determining to separately adjust the generator electromagnetic torque in the operation data of the wind turbine; the power generation of the wind power generator group comprises: determining, by means of a fifth formula and according to a component of an electric power regulation amount, data of an influencing factor and feature data of the wind power generator group, an electromagnetic torque of a generator in operation data of the wind power generator group to be separately adjusted, a fifth formula is:

$${P}_{SWi ( t )} = {k}_{Si} * {k}_{Ii} * {k}_{Ai} * {k}_{Qi} * {k}_{Ci} * \frac{{D}_{i} * {A}_{i} * {v}_{i}^{3}}{2} + {k}_{SWi 2} * {P}_{SWi ( t )}^{T} ,$$

k_{SWi2} representing a regulation coefficient of a generator electromagnetic torque of an ith wind power generator group.

In this embodiment, when an electromagnetic torque of a generator is separately adjusted, information of the Internet of things can be used to share data security management on output power of a wind power generator unit at sea, and then the output power of the wind power generator unit at the ith time segment t is adjusted and controlled as shown in the fifth formula.

In addition, the above formula can be transformed as

$${P}_{SWi ( t )} = {k}_{Wi} * {k}_{Ci} * \frac{{D}_{i} * {A}_{i} * {v}_{i}^{3}}{2} + {k}_{SWi 2} * {P}_{SWi ( t )}^{ω} .$$

the above-mentioned wind power generator unit electromagnetic torque adjustment is coefficient set to:

$$\{ \begin{matrix}{k}_{SWi 2} ( t ) ∈ [ 0 , 0.3 ] , & Δ {P}_{SWi 2} ( t ) = {k}_{SWi 2} Δ {\tilde{P}}_{SWi} ( t ) & 0 \leq Δ v ( t ) \leq {k}_{v 1} v ( t - 1 ) \\ {k}_{SWi 2} ( t ) ∈ ( 0.3 , 0.5 ] , & Δ {P}_{SWi 2} ( t ) = {k}_{SWi 2} ( t ) Δ {\tilde{P}}_{SWi} ( t ) & {k}_{v 1} v ( t - 1 ) < Δ v ( t ) \leq {k}_{v 2} v ( t - 1 ) \\ {k}_{SWi 2} ( t ) ∈ ( ( 0.5 , 0.8 ] , & Δ {P}_{SWi 2} ( t ) = {k}_{SWi 2} ( t ) Δ {\tilde{P}}_{SWi} ( t ) & {k}_{v 2} v ( t - 1 ) < Δ v ( t ) \leq {k}_{v 3} v ( t - 1 ) \\ {k}_{SWi 2} ( t ) ∈ ( 0.8 , 1. ] , & Δ {P}_{SWi 2} ( t ) = {k}_{SWi 2} ( t ) Δ {\tilde{P}}_{SWi} ( t ) & {k}_{v 3} v ( t - 1 ) < Δ v ( t ) \leq {k}_{v 4} v ( t - 1 )\end{matrix} .$$

According to the described embodiment of the present invention, when determining, according to the electric power regulation component, the influence factor data and the characteristic data of the wind turbine set, to separately adjust the rotational speed of the wind turbine in the operation data of the wind turbine set, the power generation of the wind power generator group comprises: determining, by means of a sixth formula and according to the component of the electric power regulation amount, the data of the influencing factor and the feature data of the wind power generator group, when the rotational speed of the wind turbine in the operation data of the wind power generator group is separately adjusted, a power generation capacity of a wind turbine generator set, wherein a sixth formula is:

$${P}_{SWi ( t )} = {k}_{Si} * {k}_{Ii} * {k}_{Ai} * {k}_{Qi} * {k}_{Ci} * \frac{{D}_{i} * {A}_{i} * {v}_{i}^{3}}{2} + {k}_{SWi 3} * {P}_{SWi ( t )}^{T} ,$$

k_{SWi3} representing a regulation coefficient of a wind wheel rotation speed of an ith wind turbine generator set.

In this embodiment, when the rotation speed of the wind turbine is separately adjusted, information of the Internet of things can be used to share data security management on the output power of the wind turbine generator set at sea, and then the output power of the wind turbine generator set at the ith time segment t is adjusted and controlled as shown in the sixth formula.

The rotation speed adjustment coefficient of the impeller of the described wind power generator unit set to: is

$$\{ \begin{matrix}{k}_{SWi 3} ( t ) ∈ [ 0 , 0.3 ] , & Δ {P}_{SWi 3} ( t ) = {k}_{SWi 3} Δ {\tilde{P}}_{SWi} ( t ) & 0 \leq Δ v ( t ) \leq {k}_{v 1} v ( t - 1 ) \\ {k}_{SWi 3} ( t ) ∈ ( 0.3 , 0.5 ] , & Δ {P}_{SWi 3} ( t ) = {k}_{SWi 3} ( t ) Δ {\tilde{P}}_{SWi} ( t ) & {k}_{v 1} v ( t - 1 ) < Δ v ( t ) \leq {k}_{v 2} v ( t - 1 ) \\ {k}_{SWi 3} ( t ) ∈ ( 0.5 , 0.8 ] , & Δ {P}_{SWi 3} ( t ) = {k}_{SWi 3} ( t ) Δ {\tilde{P}}_{SWi} ( t ) & {k}_{v 2} v ( t - 1 ) < Δ v ( t ) \leq {k}_{v 3} v ( t - 1 ) \\ {k}_{SWi 3} ( t ) ∈ ( 0.8 , 1. ] , & Δ {P}_{SWi 3} ( t ) = {k}_{SWi 3} ( t ) Δ {\tilde{P}}_{SWi} ( t ) & {k}_{v 3} v ( t - 1 ) < Δ v ( t ) \leq {k}_{v 4} v ( t - 1 )\end{matrix} .$$

According to the technical solutions provided in the foregoing embodiments of the present invention, a data security management method in power generation control of a wind power generator unit is adopted, which overcomes the shortcomings of the prior art. The basic principle of data security management in power generation control of a wind power generator unit is to acquire real-time data, such as marine wind speed, air density, wind turbulence, wind direction, wind volume, and sea wave, by using an electricity Internet of Things system; considering different levels of change in individual adjustment of gearbox step-up ratio, generator electromagnetic torque, and wind wheel rotation speed, etc., and using individual adjustment of the gearbox step-up ratio of the unit, the generator electromagnetic torque, and the wind wheel rotation speed, etc., to control the output of the wind power generator unit, so that the output of the wind power generator unit satisfies the requirements of a scheduled power grid, and at the same time, the influences of wind speed, air density, wind turbulence, wind direction, wind volume, and sea wave, etc. are integrated in the calculation of the output of the wind power generator unit.

In the method, different orders of change are individually adjusted in consideration of a gearbox speed increase ratio, an electromagnetic torque of a generator, a rotation speed of a wind wheel, etc., and the influences of the wind speed, the air density, the wind turbulence, the wind direction, the wind volume, the sea wave, etc. are considered. The output of a wind power generator unit is controlled by individually adjusting the gearbox speed increase ratio of the unit, the electromagnetic torque of the generator, the rotation speed of the wind wheel, etc., and a data security management method in power generation control of the wind power generator unit is proposed.

The method for safely managing power generation data of a wind power generation set of an intelligent Internet of Things can calculate a data safety regulation and control amount of power regulation and control of an offshore wind power generation set when a speed increase ratio of a gearbox, an electromagnetic torque of a generator, and a rotation speed of a wind wheel are separately adjusted. The safety management method for power generation data of a wind power generator unit adapting to the Internet of Things. At the same time, the influences of wind speed, air density, wind turbulence, wind direction, wind volume, sea wave, etc. are considered, the performance of active power control of the wind power generator unit is improved, the demand of a power grid for the expected stable power output of marine wind power supply is satisfied, theoretical guidance is provided for grid scheduling and power generation control, and necessary technical support is provided for the scheduling operation of new energy power generation and an intelligent power grid.

In conclusion, in the embodiments of the present invention, the output of the wind turbine generator set is affected by the speed of the incoming wind, the density of the air, the intermittency of the incoming wind, the wind direction, the volume of the wind, the sea wave, and the like, and is also affected by the speed increase ratio of the gearbox, the electromagnetic torque of the generator, and the rotation speed of the wind wheel being separately adjusted. Data security management in power generation control of a wind power generator unit. Information sharing and data fusion technology of the Internet of things can be separately adjusted by using a speed increase ratio of a gearbox of a unit, an electromagnetic torque of a generator, a rotation speed of a wind wheel, etc., different levels of changes are separately adjusted in consideration of the speed increase ratio of the gearbox, the electromagnetic torque of the generator, the rotation speed of the wind wheel, etc., and influences of wind speed, air density, wind turbulence, wind direction, wind volume, sea wave, etc. are considered. Furthermore, in the method, an expert assessment method can be used to determine, according to operation data, individual adjustment and control coefficients of a gearbox step-up ratio, an electromagnetic torque of a generator, and a rotation speed of a wind turbine of a wind turbine, so as to calculate an adjustment and control amount of a wind turbine output.

It should be noted that, for brevity of description, the foregoing method embodiments are described as a series of actions. However, persons skilled in the art should understand that the present application is not limited to the described order of actions, because according to the present application, some steps may be performed in another order or simultaneously. Secondly, those skilled in the art should also know that the embodiments described in the description are all preferred embodiments, and the involved actions and modules are not necessarily required in the present application.

Through the description of the foregoing embodiments, a person skilled in the art may clearly understand that the method according to the foregoing embodiments may be implemented by software in addition to a necessary universal hardware platform, and definitely may also be implemented by hardware. However, in many cases, the former is a preferred implementation. Based on such understanding, the technical solutions of the present application essentially or the part contributing to the prior art may be embodied in the form of a software product. The computer software product is stored in a storage medium (such as a ROM/RAM, a magnetic disk, or an optical disk), and includes several instructions for instructing a terminal device (which may be a mobile phone, a computer, a server, or a network device) to execute the methods of various embodiments of the present application.

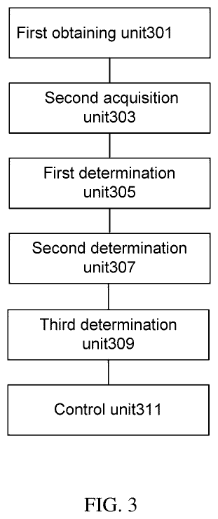

According to an embodiment of the present invention, a power generation control device for a wind power generator unit for implementing the above power generation control method for a wind power generator unit is further provided. FIG. 3 is a schematic diagram of a power generation control device for a wind power generator unit according to an embodiment of the present invention. As shown in FIG. 3, the device comprises: a first acquisition unit 301, a second acquisition unit 303, a first determination unit 305, a second determination unit 307, a third determination unit 309, and a control unit 311. The power generation control device for the wind power generator unit will be described in detail below.

A first obtaining unit 301, configured to obtain running data generated during running of a wind turbine generator group.

A second acquisition unit 303 used for acquiring data of an influence factor of a wind power generator group, wherein the data of the influence factor is data corresponding to various factors in an area where the wind power generator group is located, the factors influencing the power generation of the wind power generator group.

A first determining unit 305, configured to determine, according to the operation data and the factor data, an electric power generation power regulation component of the wind turbine generator group when the operation data of the wind turbine generator group is separately adjusted.

A second determining unit 307, configured to determine, according to the electric power generation power regulation component, the influence factor data and the feature data of the wind turbine generator set, the electric power generation power of the wind turbine generator set when each piece of operation data of the wind turbine generator set is separately adjusted.

A third determining unit 309, configured to determine a regulation and control manner for each piece of operation data according to the magnitude of the generated power.

And a control unit 311, configured to control an operating mode of the wind turbine generator group according to the regulation and control mode, so that a power generation behavior of the wind turbine generator group satisfies a power grid demand.

It should be noted here that, the first obtaining unit 301, the second obtaining unit 303, the first determining unit 305, the second determining unit 307, the third determining unit 309, and the control unit 311 correspond to step S202 to step S212 in the foregoing embodiment, and examples and application scenarios implemented by the five units are the same as those implemented by the corresponding steps, but are not limited to the content disclosed in the foregoing embodiment.

It can be seen from the foregoing that, in the solutions described in the foregoing embodiments of the present invention, the first obtaining unit may be used to obtain operation data generated during running of the wind turbine generator group; next, using a second acquisition unit to acquire data of an influence factor of a wind turbine generator group, in which the data of the influence factor is data corresponding to various factors in a region where the wind turbine generator group is located, the factors influencing the power generation of the wind turbine generator group; using a first determination unit to determine, according to the operation data and the data of the influence factors, a component of an electric power generation power regulation and control quantity of the wind power generator group when each piece of operation data of the wind power generator group is independently adjusted; using a second determination unit to determine, according to the components of the electric power regulation amount, the data of the influence factors and the feature data of the wind power generator unit, the power generation power of the wind power generator unit when each piece of operation data of the wind power generator unit is independently adjusted; determining a regulation and control manner of each piece of operation data according to the magnitude of the sent electric power by using a third determination unit; a control unit is used to control an operation mode of a wind power generator group according to a regulation and control mode, so that a power generation behavior of the wind power generator group satisfies a power grid requirement, thereby achieving the purpose of separately adjusting a speed increase ratio of a gearbox, an electromagnetic torque of a generator and a rotation speed of a wind wheel, so as to safely regulate and control the power of the wind power generator group, achieving the technical effect of improving the power generation stability of the wind power generator group, and at the same time, enabling the output of the wind power generator group to satisfy the power grid scheduling requirement.

Therefore, by means of the method for controlling power generation of a wind turbine generator set provided in the embodiments of the present invention, the technical problem is solved.

In an optional embodiment, the first acquiring unit comprises: a first acquiring module, configured to acquire running data generated during running of a wind turbine generator set by using an electric Internet of Things system.

In an optional embodiment, the second acquisition unit comprises: a second acquisition module for acquiring, via the power Internet of things system, data of an influence factor of a wind turbine generator group, wherein the data of the influence factor at least comprises wind power-related data and air density data of an area where the wind turbine generator group is located.

In an exemplary embodiment, the first determination unit may include: a first determination module configured to determine, according to a first formula, when determining, according to the operation data and the factor data, to separately adjust a gearbox step-up ratio in the operation data of the wind power generator group, a power generation power regulation component of a wind power generator unit, wherein a first formula is: ΔP_{SWi}^{ω}(t)=k_{Wi}n_{SWi}(t−1)T_{SWGi}(t−1)Δω_{SWi}(t), ΔP_{SWi}(t) representing a power generation power regulation component of an ith wind power generator unit in a t-period, n_{SWi}(t−1) represents a gearbox step-up ratio of the ith wind power generator group in the t−1 period, and T_{SWGi}(t−1) represents an electromagnetic generator torque of the ith wind power generator group in the t−1 period, Δω_{SWFi}(t) represents the regulation component of the rotation speed of the wind rotor of the ith wind motor group in the t time period, and k_{wi}=k_{Si}*k_{Ii}*k_{Ai}*k_{Qi}*k_{Ci}, k_{Si} represents the influence coefficient of the wind speed in the region where the ith wind motor group is located, Khi represents the influence coefficient of the incoming air turbulence in the area where the ith wind turbine generator group is located, and k_{Ai} represents the influence coefficient of the wind direction in the area where the ith wind turbine generator group is located, k_{Qi} represents the influence coefficient of the amount of wind power coming into the zone where the ith wind turbine generator group is located, and k_{Ci} represents the conversion efficiency of wind power at sea in the zone where the ith wind turbine generator group is located.

In an optional embodiment, the first determining unit includes: a second determining unit, configured to determine, according to a second formula, when determining, according to the operation data and the data of the influence factors, to separately adjust the generator electromagnetic torque in the operation data of the wind power generator group, a power generation power regulation component of a wind power generator unit, wherein a second formula is: ΔP_{SWi}^{T}(t)=k_{Wi}ω_{SWEi}(t−1)n_{SWi}(t−1)ΔT_{SWGi}(t), ΔP_{SWi(t)} representing a power generation power regulation component of an ith wind power generator unit in a time period t when an electromagnetic torque of a generator is separately adjusted, ω_{SWEi}(t−1) denotes a gearbox step-up ratio of the ith wind power generator group in the t−1 period, and ΔT_{SWGi}(t) denotes a regulation component of an engine electromagnetic torque of the ith wind power generator group in the t−1 period.

In an exemplary embodiment, the first determination unit may include: a third determination unit configured to determine, according to a third formula, when determining, according to the operation data and the data of the influence factors, to separately adjust the rotation speed of the wind turbine in the operation data of the wind turbine generator group, a power generation power regulation component of a wind power generator unit, wherein a third formula is: ΔP_{SWi}^{a}(t)=k_{Wi}ω_{SWEi}(t−1)T_{SWCi}(t−1)Δn_{SWi}(t), ΔP_{SWi(t)} representing a power generation power regulation component of an ith wind power generator unit during a time period t when the rotational speed of a wind wheel is separately adjusted, Δn_{SWi}(t) regulation component representing gearbox step-up ratio of ith wind power generator group in t time period.

In an exemplary embodiment, the second determination unit may include: a fourth determination unit configured to determine, according to a fourth formula, when it is determined to separately adjust a gearbox step-up ratio in operation data of the wind power generator group according to the components of the electric power regulation and control amount, the data of the influencing factor and the characteristic data of the wind power generator group, the electric power generation power of the wind turbine generator group, wherein a fourth formula is:

$${P}_{SWi ( t )} = {k}_{Si} * {k}_{Ii} * {k}_{Ai} * {k}_{Qi} * {k}_{Ci} * \frac{{D}_{i} * {A}_{i} * {v}_{i}^{3}}{2} + {k}_{SWi 1} * {P}_{SWi ( t )}^{ω} ,$$

P_{SWi (t)} denotes the generation power of the ith wind turbine generator group in the t time period, Dᵢ denotes the air density of the area where the ith wind turbine generator group is located, Aᵢ denotes the swept air area of the ith wind turbine generator group, vᵢ denotes the wind speed of the ith wind turbine generator group, and k_{SWi1} denotes the regulation coefficient of the gearbox step-up ratio of the ith wind turbine generator group.

In an optional embodiment, the second determining unit comprises: a fifth determining unit, configured to determine, according to a fifth formula and according to a component of an electric power regulation amount, data of an influencing factor and feature data of a wind turbine generator set, a power generation power of the wind turbine generator set when an electromagnetic torque of a generator in operation data of the wind turbine generator set is separately adjusted, wherein the fifth formula is:

$${P}_{SWi ( t )} = {k}_{Si} * {k}_{Ii} * {k}_{Ai} * {k}_{Qi} * {k}_{Ci} * \frac{{D}_{i} * {A}_{i} * {v}_{i}^{3}}{2} + {k}_{SWi 2} * {P}_{SWi ( t )}^{T} ,$$

and k_{SWi2} represents a regulation coefficient of an electromagnetic torque of the generator of an ith wind turbine generator set.

In an optional embodiment, the second determining unit comprises: a sixth determining unit, configured to determine, according to a sixth formula and according to a component of an electric power regulation amount, data of an influence factor and feature data of a wind turbine generator set, a power generation power of the wind turbine generator set when a rotational speed of a wind turbine in running data of the wind turbine generator set is separately adjusted, wherein the sixth formula is:

$${P}_{SWi ( t )} = {k}_{Si} * {k}_{Ii} * {k}_{Ai} * {k}_{Qi} * {k}_{Ci} * \frac{{D}_{i} * {A}_{i} * {v}_{i}^{3}}{2} + {k}_{SWi 3} * {P}_{SWi ( t )}^{T} ,$$

k_{SWi3} representing a regulation coefficient of the rotational speed of the wind turbine of an ith wind turbine generator set.

According to another aspect of the embodiments of the present invention, a computer-readable storage medium is further provided. The computer-readable storage medium comprises a stored program, wherein the program executes the power generation control method for a wind turbine generator set according to any one of the described items.

Optionally, in this embodiment, the computer readable storage medium may be located in any computer terminal in a computer terminal group in a computer network, or located in any communication device in a communication device group.

Optionally, in the embodiment, the computer readable storage medium is configured to store a program code for executing the following steps: acquiring running data generated during running of the wind turbine generator set; acquiring data of an influence factor of a wind turbine generator group, wherein the data of the influence factor is data corresponding to various factors in an area where the wind turbine generator group is located, the factors affecting power generation of the wind turbine generator group; determining, according to the operation data and the influence factor data, a component of an electric power generation power regulation component of the wind power generator group when each operation data of the wind power generator group is independently adjusted; determining, according to the components of the electric power regulation and control amount, the data of the influencing factor and the feature data of the wind power generator unit, the electric power generation power of the wind power generator unit when each piece of operation data of the wind power generator unit is independently adjusted; determining a regulation and control mode of each piece of operation data according to the magnitude of the power supply; controlling an operating mode of a wind power generator group according to a regulation and control mode, so that a power generation behavior of the wind power generator group satisfies a power grid demand.

Optionally, in the embodiment, the computer readable storage medium is configured to store a program code for executing the following steps: acquiring running data generated during running of the wind turbine generator set by the electric Internet of Things system.

Alternatively, in this embodiment, the computer-readable storage medium is configured to store a program code for executing the following steps: acquiring, by means of an electric Internet of Things system, data of an influence factor of a wind power generator group, wherein the data of the influence factor at least comprises wind power-related data and air density data of an area where the wind power generator group is located.

Alternatively, in this embodiment, the computer-readable storage medium is arranged to store program code for performing the steps of, when determining, according to the operation data and the factor data, to separately adjust a gearbox step-up ratio in the operation data of the wind power generator group, a power generation power regulation component of a wind power generator unit, wherein a first formula is ΔP_{SWi}^{ω}(t)=k_{Wi}n_{SWi} (t−1)T_{SWGi}(t−1)Δω_{SWi}(t), ΔP_{SWi}(t) represents a power generation power regulation component of an ith wind power generator unit in a t time period, n_{SWi}(t−1) represents the gearbox step-up ratio of the ith wind power generator group in the t−1 period, and T_{SWGi}(t−1) represents the generator electromagnetic torque of the ith wind power generator group in the t−1 period, Δω_{SWEi}(t) represents the regulation component of the rotation speed of the wind rotor of the ith wind motor group in the t time period, and k_{wi}=k_{Si}*k_{Ii}*k_{Ai}*k_{Qi}*k_{Ci}, k_{Si} represents the influence coefficient of the wind speed in the region where the ith wind motor group is located, k_{Ii} represents the influence coefficient of the incoming air turbulence in the area where the ith wind turbine generator group is located, and k_{Ai} represents the influence coefficient of the wind direction in the area where the ith wind turbine generator group is located, k_{Qi} denotes the influence coefficient of the amount of wind coming from the area where the ith wind turbine generator group is located, and k_{Ci} denotes the efficiency of converting wind energy at sea in the area where the ith wind turbine generator group is located.

Alternatively, in this embodiment, the computer readable storage medium is arranged to store program code for performing the steps of, when determining, according to the operation data and the data of the influence factors, to separately adjust the generator electromagnetic torque in the operation data of the wind power generator group, a power generation power regulation component of a wind power generator unit, wherein a second formula is: ΔP_{SWi}^{T}(t)=k_{Wi}ω_{SWFi}(t−1)n_{SWi}(t−1)ΔT_{SWGi}(t), ΔP_{SWi(t)} representing a power generation power regulation component of an ith wind power generator unit in a time period t when an electromagnetic torque of a generator is separately adjusted, ω_{SWEi}(t−1) denotes a gearbox step-up ratio of the ith wind power generator group in the t−1 period, and ΔT_{SWCi}(t) denotes a regulation component of an engine electromagnetic torque of the ith wind power generator group in the t−1 period.

Alternatively, in this embodiment, the computer-readable storage medium is arranged to store program code for performing the steps of, when determining, according to the operation data and the data of the influence factors, to separately adjust the rotation speed of the wind turbine in the operation data of the wind turbine generator group, a power generation power regulation component of a wind power generator unit, wherein a third formula is: ΔP_{SWi}ⁿ(t)=k_{Wi}ω_{SWEi}(t−1)T_{SWGi}(t−1)Δn_{SWi}(t), ΔP_{SWi(t)} representing a power generation power regulation component of an ith wind power generator unit during a time period t when the rotational speed of a wind wheel is separately adjusted, a regulation component Δn_{SWi}(t) representing a gearbox step-up ratio of the ith wind power generator group in the t time period.

Alternatively, in this embodiment, the computer-readable storage medium is arranged to store program code for performing the steps of, when it is determined to separately adjust a gearbox step-up ratio in operation data of the wind power generator group according to the components of the electric power regulation and control amount, the data of the influencing factor and the characteristic data of the wind power generator group, the electric power generation power of the wind turbine generator group, wherein a fourth formula is:

$${P}_{SWi ( t )} = {k}_{Si} * {k}_{Ii} * {k}_{Ai} * {k}_{Qi} * {k}_{Ci} * \frac{{D}_{i} * {A}_{i} * {v}_{i}^{3}}{2} + {k}_{SWi 1} * {P}_{SWi ( t )}^{ω} ,$$

P_{SWi(t)} denotes the generation power of the ith wind turbine generator group in the t time period, Dᵢ denotes the air density of the area where the ith wind turbine generator group is located, Aᵢ denotes the swept air area of the ith wind turbine generator group, vᵢ denotes the wind speed of the ith wind turbine generator group, and k_{SWi1} denotes the regulation coefficient of the gearbox step-up ratio of the ith wind turbine generator group.

Alternatively, in this embodiment, the computer readable storage medium is configured to store a program code for executing the following steps: determining, according to a fifth formula and according to a component of an electric power regulation amount, data of an influencing factor and feature data of a wind turbine generator set, power generation power of the wind turbine generator set when separately adjusting an electromagnetic torque of a generator in operation data of the wind turbine generator set, where the fifth formula is:

$${P}_{SWi ( t )} = {k}_{Si} * {k}_{Ii} * {k}_{Ai} * {k}_{Qi} * {k}_{Ci} * \frac{{D}_{i} * {A}_{i} * {v}_{i}^{3}}{2} + {k}_{SWi 2} * {P}_{SWi ( t )}^{T} ,$$

k_{SWi2} denotes a regulation coefficient of an electromagnetic torque of a generator of an ith wind turbine generator set.

Alternatively, in the present embodiment, the computer readable storage medium is configured to store a program code for executing the following steps: determining, according to a sixth formula and according to the electric power regulation component, the influence factor data and the characteristic data of the wind turbine generator set, the electric power generation power of the wind turbine generator set when the rotational speed of the wind turbine in the operational data of the wind turbine generator set is separately adjusted, wherein the sixth formula is

$${P}_{SWi ( t )} = {k}_{Si} * {k}_{Ii} * {k}_{Ai} * {k}_{Qi} * {k}_{Ci} * \frac{{D}_{i} * {A}_{i} * {v}_{i}^{3}}{2} + {k}_{SWi 3} * {P}_{SWi ( t )}^{T} ,$$

and k_{SWi3} denotes a regulation coefficient for the rotational speed of the wind turbine of the ith wind turbine generator set.

According to another aspect of the embodiments of the present invention, a processor is further provided, and the processor is used for running a program, wherein when the program is running, the method for controlling power generation of a wind turbine generator set according to any one of the described items is executed.

The sequence numbers of the embodiments of the present invention are only for description, and do not represent the preference of the embodiments.

In the foregoing embodiments of the present invention, descriptions of the embodiments are focused on each other, and for a part that is not described in detail in a certain embodiment, reference may be made to related descriptions of other embodiments.

In the several embodiments provided in the present application, it should be understood that the disclosed technical content may be implemented in other manners. The apparatus embodiments described above are merely exemplary. For example, the division of the units may be logical function division, and may be other division in actual implementation. For example, a plurality of units or components may be combined or integrated into another system, or some features may be ignored or not executed. In addition, the displayed or discussed mutual couplings or direct couplings or communication connections may be implemented through some interfaces. The indirect couplings or communication connections between units or modules may be implemented in electronic or other forms.

The units described as separate parts may or may not be physically separate, and parts displayed as units may or may not be physical units, may be located in one position, or may be distributed on a plurality of units. A part or all of the units may be selected according to actual requirements to achieve the objectives of the solutions of the embodiments.

In addition, functional units in the embodiments of the present invention may be integrated into one processing unit, or each of the units may exist alone physically, or two or more units are integrated into one unit. The integrated unit may be implemented in a form of hardware, and may also be implemented in a form of a software functional unit.

If the integrated unit is implemented in the form of a software functional unit and sold or used as an independent product, the integrated unit may be stored in a computer readable storage medium. Based on such an understanding, the technical solutions of the present invention essentially, or the part contributing to the prior art, or all or a part of the technical solutions may be implemented in the form of a software product. The computer software product is stored in a storage medium, and includes several instructions for instructing a computer device (which may be a personal computer, a server, a network device, or the like) to perform all or a part of the steps of the methods described in the embodiments of the present invention. The foregoing storage medium includes: any medium that can store program codes, such as a USB flash disk, a read-only memory (ROM, Read-Only Memory), a random access memory (RAM, Random Access Memory), a removable hard disk, a magnetic disk, or an optical disk.

The above are only preferred embodiments of the present invention. It should be noted that, a person of ordinary skill in the art may make further improvements and modifications without departing from the principle of the present invention, and these improvements and modifications shall also belong to the scope of protection of the present invention.

What is claimed is:

1. A method for controlling power generation of a wind power generator unit, comprising:
acquiring operation data generated during an operation of a wind power generation unit;
acquiring data of an influence factor of the wind power generator unit, wherein the data of influence factor is data corresponding to each factor in an area where the wind power generator unit is located, wherein influence factors the wind power generator unit to generate electricity;
determining, according to the operation data and the data of influence factor, an electric power generation power regulation component of the wind turbine generator set when the operation data of the wind turbine generator set is separately adjusted;
determining, according to the electric power generation power regulation component, the data of influence factor and feature data of the wind turbine generator set, the electric power generated by the wind turbine generator set when the running data of the wind turbine generator set is separately adjusted;
determining a regulation and control manner of each piece of operation data according to the magnitude of the generated power; and
controlling an operating mode of the wind power generator group according to the regulation and control mode, so that a power generation behavior of the wind power generator group satisfies a power grid demand.

2. The method for controlling power generation of the wind power generator unit according to claim 1, wherein the acquiring operation data generated during operation of the wind turbine generator set comprises:
acquiring, by using an electric Internet of Things system, the operation data generated in the running process of the wind turbine generator set.

3. The method for controlling power generation of the wind power generator unit according to claim 1, wherein the acquiring data of an influence factor of the wind turbine generator set comprises:
acquiring the data of the influence factors of the wind power generator group via a power Internet of things system, wherein the data of the influence factors at least comprise wind power-related data and air density data of an area where the wind power generator group is located.

4. The method for controlling power generation of the wind power generator unit according to claim 1, wherein that when determining, according to the operation data and the influence factor data, to separately adjust a gearbox step-up ratio in the operation data of the wind power generator unit, the electric power generation power regulation component of the wind power generator unit comprises:
when it is determined, by a first formula and according to the operation data and the influence factor data, to independently adjust a gearbox step-up ratio in the operation data of the wind power generator group, the electric power generation power regulation component of the wind turbine generator set, wherein the first formula is as follows: ΔP_{SWi}^{ω}(t)=k_{Wi}n_{SWi}(t−1)T_{SWGi}(t−1)Δω_{SWi}(t), ΔP_{SWi}(t) represents the electric power generation power regulation component of the ith wind turbine generator set in t time period, n_{Swi}(t−1) represents a gearbox step-up ratio of the ith wind power generator group in the t−1 time period, and T_{SWGi}(t−1) represents a generator electromagnetic torque of the ith wind power generator group in the t−1 time period, Δω_{SWEi}(t) represents the regulation component of the rotation speed of the wind rotor of the ith wind motor group in the t time period, and k_{wi}=k_{Si}*k_{Ii}*k_{Ai}*k_{Qi}*k_{Ci}, k_{Si} represents the influence coefficient of the wind speed in the region where the ith wind motor group is located, kᵢᵢ represents a coefficient of influence of wind turbulence in an area where the ith wind turbine generator group is located, and k_{Ai} represents a coefficient of influence of wind direction in an area where the ith wind turbine generator group is located, k_{Qi} represents the influence coefficient of the amount of wind power coming from the area where the ith wind turbine generator group is located, and k_{Ci} represents the efficiency of converting wind power at sea in the area where the ith wind turbine generator group is located.

5. The method for controlling power generation of the wind power generator unit according to claim 1, wherein when determining, according to the operation data and the factor data, separately adjusting the generator electromagnetic torque in the operation data of the wind turbine generator set, the components of the generator power regulation and control of the wind turbine generator set comprise:
determining, by using a second formula and according to the operation data and the influence factor data, to separately adjust the generator electromagnetic torque in the operation data of the wind power generator group, an electric power generation power regulation component of the wind power generator unit, wherein the second formula is: ΔP_{SWi}^{T}(t)=k_{Wi}ω_{SWEi}(t−1)n_{SWi}(t−1)ΔT_{SWGi}(t), P_{SWi(t)} representing an electric power generation power regulation component of the wind power generator unit in the ith time period t when the electromagnetic torque of the generator is separately adjusted, ω_{SWEi}(t−1) denotes a gearbox step-up ratio of the ith wind turbine generator set in the t−1 period, and ΔT_{SWGi}(t) denotes a regulation component of an engine electromagnetic torque of the ith wind turbine generator set in the t−1 period.

6. The method for controlling power generation of the wind power generator unit according to claim 1, wherein when determining, according to the operation data and the data of the influence factors, to separately adjust the rotation speed of the wind turbine in the operation data of the wind turbine generator set, the component of the electric power generation regulation component of the wind turbine generator set comprises:
determining, by using a third formula and according to the operation data and the influence factor data, to separately adjust a rotation speed of a wind turbine in the operation data of the wind turbine generator group, an electric power generation power regulation component of the wind turbine generator set, wherein the third formula is: ΔP_{SWi}ⁿ(t)=k_{Wi}ω_{SWEi}(t−1)T_{SWGi}(t−1)Δn_{SWi}(t), ΔP_{SWi(t)} which represents an electric power generation power regulation component of the ith wind turbine generator set during a time period t when the rotational speed of the wind turbine wheel is separately adjusted, Δn_{SWi}(t) is regulation component representing a gearbox step-up ratio of the ith said wind power generator group in the t time period.

7. The method for controlling power generation of the wind power generator unit according to claim 1, wherein that when determining, according to the electric power generation power regulation component, the influence factor data and the feature data of the wind turbine generator set, to separately adjust a gearbox step-up ratio in the operation data of the wind turbine generator set, the electric power generation of the wind turbine generator set comprises:
when it is determined, by a fourth formula and according to the electric power generation power regulation component, the influence factor data and the characteristic data of the wind power generator unit, to separately adjust a gearbox step-up ratio in the operation data of the wind power generator unit, the generating power of the wind turbine generator group, wherein the fourth formula is:
$${P}_{SWi ( t )} = {k}_{Si} * {k}_{Ii} * {k}_{Ai} * {k}_{Qi} * {k}_{Ci} * \frac{{D}_{i} * {A}_{i} * {v}_{i}^{3}}{2} + {k}_{SWi 1} * {P}_{SWi ( t )}^{ω} ,$$
P_{SWi(t)} represents the generating power of the ith wind turbine generator group in the t time period, Dᵢ indicates an air density of a region where the ith air motor group is located, and Aᵢ indicates a swept area of the ith air motor group, vᵢ represents a wind speed of the ith wind power generator group, and k_{SWi1} represents a regulation coefficient of a gearbox step-up ratio of the ith wind power generator group.

8. The method for controlling power generation of the wind power generator unit according to claim 1, wherein that when determining separately adjusting the generator electromagnetic torque in the operation data of the wind turbine generator set according to the power generation power regulation component, the influence factor data and the feature data of the wind turbine generator set, the power generation of the wind turbine generator set comprises:
determining, according to the electric power generation power regulation component, the influence factor data, and the characteristic data of the wind power generator group, the electric power generation power of the wind power generator group when separately adjusting the electric generator electromagnetic torque in the operation data of the wind power generator group, wherein the fifth formula is:
$${P}_{SWi ( t )} = {k}_{Si} * {k}_{Ii} * {k}_{Ai} * {k}_{Qi} * {k}_{Ci} * \frac{{D}_{i} * {A}_{i} * {v}_{i}^{3}}{2} + {k}_{SWi 2} * {P}_{SWi ( t )}^{T} ,$$
k_{SWi2} represents a regulation coefficient of a generator electromagnetic torque of an ith wind power generator group.

9. The electric power generation control method for the wind power generator unit according to claim 1, wherein that when determining, according to the electric power generation power regulation component, the influence factor data and the feature data of the wind turbine generator set, to separately adjust the rotational speed of the wind turbine in the operation data of the wind turbine generator set, the electric power generation of the wind turbine generator set comprises:
determining, according to the electric power generation power regulation component, the influence factor data and the characteristic data of the wind turbine generator set, the electric power generation power of the wind turbine generator set when separately adjusting the rotational speed of the wind turbine in the operation data of the wind turbine generator set, wherein the sixth formula is:
$${P}_{SWi ( t )} = {k}_{Si} * {k}_{Ii} * {k}_{Ai} * {k}_{Qi} * {k}_{Ci} * \frac{{D}_{i} * {A}_{i} * {v}_{i}^{3}}{2} + {k}_{SWi 3} * {P}_{SWi ( t )}^{T} ,$$
k_{SWi3} represents a regulation coefficient of the rotational speed of the wind turbine of the ith wind turbine generator set.

10. A power generation control device for a wind power generator unit, comprising:
a first obtaining unit, configured to obtain running data generated during running of a wind turbine generator set;
a second acquisition unit for acquiring data of an influence factor of the wind power generator group, wherein the data of the influence factor is data corresponding to each factor in an area where the wind power generator group is located which influences the power generation of the wind power generator group;
a first determining unit, configured to determine, according to the operation data and the influence factor data, an electric power generation power regulation component of the wind turbine generator set when the operation data of the wind turbine generator set is separately adjusted;
a second determining unit, configured to determine, according to the power generation power regulation component, the influence factor data, and feature data of the wind turbine generator group, power generation of the wind turbine generator group when the running data of the wind turbine generator group is separately adjusted;
a third determining unit, configured to determine a regulation manner of each piece of operation data according to the power generation capacity; and
a control unit for controlling an operating mode of the wind power generator group according to the regulation and control mode, so that a power generation behavior of the wind power generator group satisfies a power grid demand.
